(19) United States
(12) Patent Application Publication
(10) Pub. No.: US 2023/0327810 A1
(43) Pub. Date: Oct. 12, 2023

(54) HANDLING BLOCK ACKNOWLEDGEMENTS

(71) Applicant: Hewlett Packard Enterprise Development LP, Houston, TX (US)

(72) Inventors: Jianpo HAN, Beijing (CN); Liao XU, Beijing (CN); Yu JUN, Beijing (CN)

(21) Appl. No.: 17/715,104

(22) Filed: Apr. 7, 2022

(51) Int. Cl. H04L 1/16; H04L 1/18; H04L 1/00

(52) U.S. Cl. CPC H04L 1/1621; H04L 1/188; H04L 1/0007; H04W 84/12

(57) ABSTRACT

Examples described herein relate to a method of handling block acknowledgements. A transmitting device transmits a first packet to a receiving device in response to determining that a count of unacknowledged frames is smaller than a threshold value. In particular, the transmitting device configures the first packet such that the receiving device does not need to send a block acknowledgement (BA) immediately after receiving the first packet. Further, before transmitting any additional packet to the receiving device, the transmitting device may again ascertain whether the count of the unacknowledged frames is smaller than the threshold value. In response to determining that the count of the unacknowledged frames is greater than or equal to the threshold value, the transmitting device transmits a second packet requesting an immediate BA. The transmitting device may receive a BA for the unacknowledged frames in response to receipt of the second packet by the receiving device.

### BACKGROUND

In wireless local area network (WLAN), communication of frames such as Media Access Control (MAC) Protocol Data Unit (MPDU) between a transmitting device and a receiving device involves a significant overhead due to the transmission of respective header control fields, need for an inter-frame space, and acknowledgement handling for the transmitted frames. With the increase in data rates, such overhead may incur increased airtime usage thereby reducing airtime efficiency. Use of a frame aggregation technique generally improves network throughput and airtime efficiency. With the frame aggregation, multiple frames are combined into a single transmission. Accordingly, instead of transmitting frames individually, the transmitting device may transmit an aggregated frame unit (such as an aggregated MPDU (AMPDU)) comprising multiple subframes. The receiving device may acknowledge receipt of the aggregated frame unit depending on negotiated acknowledgement policy by transmitting a block acknowledgement to the transmitting device. Transmission of the block acknowledgement also consumes airtime according to the length of the block acknowledgement frame (also referred to as block acknowledgement window or BA window size) respective buffer intervals that are required prior to the transmission of the block acknowledgement.

The BA window size is expected to grow in future implementations of wireless communication standards. However, in some cases, the number of frames in the aggregated frame unit may still be limited due to many factors such as actual data traffic being low, a transmission opportunity (TROP) limit, a multi-user (MU) fairness policy, an MU alignment, and a regulatory limit on maximum airtime occupation. When the number of frames in the aggregated frame unit is far less than the BA window size, the BA window size may be underutilized. Such underutilization of the BA window size is not very efficient considering the airtime consumed by multiple block acknowledgements and respective buffer intervals.

### BRIEF DESCRIPTION OF THE DRAWINGS

One or more examples in the present disclosure are described in detail with reference to the following figures. The figures are provided for purposes of illustration only and merely depict examples.

FIG. 1 depicts a system in which various of the examples presented herein may be implemented.

FIG. 2 depicts a flowchart of an example method for handling block acknowledgements.

FIG. 3 depicts a flowchart of another example method for handling block acknowledgements.

FIGS. 4A-4D represent example scenarios illustrating a reduction in airtime usage.

FIG. 5 depicts a block diagram of an example computing system in which various of the examples described herein may be implemented.

The figures are not exhaustive and do not limit the present disclosure to the precise form disclosed.

### DETAILED DESCRIPTION

In computer networks, frames are digital data transmission units between a transmitting device and a receiving device. A commonly used Wi-Fi frame such as an MPDU typically includes a MAC header, a frame body, and a trailing section. The frame body of the MPDU includes MAC Service Data Unit (MSDU) which is upper-layer information (e.g., layer 3-7 payload), Communications of these frames (e.g., MPDUs) between a transmitting device and a receiving device involve a significant overhead due to the transmission of header control fields, need for an inter-frame space, and acknowledgement handling for each of the transmitted frames. With an increase in data rates, such overhead may lower airtime efficiency. The airtime efficiency is a measure of what percentage of the airtime is being used to transmit user data. In particular, the overheads such as the header control fields, the need for an inter-frame space, and the exchange of acknowledgements reduces the airtime efficiency.

A technique of frame aggregation was proposed in a W-Fi standard (e.g., IEEE 802.11n) to improve network throughput and airtime efficiency. With the frame aggregation, the transmitting device combines multiple frames into an aggregated frame unit and transmits such aggregated frame unit to the receiving device. For example, in the case of an aggregated-MPDU (hereinafter referred to as AMPDU) technique, two or more frames (e.g., MSDUs) are bundled together and transmitted as an aggregated frame unit referred to as an AMPDU. Accordingly, instead of transmitting frames individually, the transmitting device may transmit an AMPDU comprising multiple frames. The receiving device may acknowledge receipt of the AMPDU depending on negotiated acknowledgement policy.

The existing Wi-Fi standards support two types of block acknowledgement policies—an immediate block acknowledgement and a delayed block acknowledgement. The acknowledgement policy may be negotiated between the transmitting device and the receiving device in advance of communicating the AMPDUs. The immediate block acknowledgement is generally used for low-latency and high-throughput traffic, for example, voice and video traffic. Whereas the delayed block acknowledgement is generally used for traffic that can tolerate moderate or low levels of latency (e.g., a best-effort (BE) traffic or a background (BK) traffic). Once negotiated, the transmitting device requests acknowledgement from the receiving device as per the agreed block acknowledgement policy (e.g., one of the immediate or delayed block acknowledgements).

The receiving device may respond to the transmitting device by sending the block acknowledgement indicating a reception status of the unacknowledged frames. In particular, each bit of the block acknowledgement may be used to indicate an acknowledgement status corresponding to an individual frame. Accordingly, a block acknowledgement having a BA window size (i.e., a number of bits in a block acknowledgement) of 64 bits can acknowledge up to 64 unacknowledged subframes. The transmission of the block acknowledgement also requires a predetermined spacing before the block acknowledgement, generally referred to as a short inter-frame spacing (SIFS). Therefore, the transmission of the block acknowledgement also consumes airtime depending on the BA window size and the SIFS.

As per the IEEE 802.11be draft, the BA window size is expected to grow up to 1024 bits—meaning a block acknowledgement of the size 1024 bits can acknowledge up to 1024 unacknowledged frames. Such a high BA window size may be very useful for multi-link transmission. However, in the case of a single link communication, the number of frames in an AMPDU is not that high due to many factors such as actual data traffic being low, a TXOP limit, an MU fairness policy, an MU alignment, and a regulatory limit on maximum airtime occupation. In some instances, the number of frames in the AMPDU may be far less than the BA window size. When the number of subframes is far less than the BA window size, the BA window size may be underutilized. Such underutilization of the BA window size is not very efficient considering the airtime consumed by multiple block acknowledgement and respective buffer intervals.

The present disclosure relates to a technique of managing block acknowledgements resulting in significant airtime savings. In accordance with some examples, an aggregate block acknowledgement method is proposed that can leverage the increased BA window size. In some examples, a transmitting device is configured to request an immediate block acknowledgement depending on the BA window size and a count of unacknowledged frames. In particular, the transmitting device may be configured to send packets with frames requiring a delayed block acknowledgement until a count of the unacknowledged frames reaches a threshold value. More particularly, in one example, the transmitting device requests the immediate block acknowledgement upon determining that the number of unacknowledged frames is greater than or equal to the threshold value. The threshold value may be set to a predetermined percentage (e.g., 75%) of the BA window size. By doing so, a major portion of the BA window size may be utilized, and frequent transmission of the block acknowledgements may be avoided.

In particular, in some examples, the transmitting device may first determine whether a count of unacknowledged frames corresponding to the receiving device (e.g., a number of frames that the received has not acknowledged at a given point in time) is smaller than the threshold value. The transmitting device may transmit a first packet to the receiving device in response to determining that the count of the unacknowledged frames is smaller than the threshold value. In particular, the transmitting device configures the first packet such that the receiving device does not need to send a block acknowledgement immediately after receiving the first packet. Further, after the transmission of the first frame and before transmitting any additional packet to the receiving device, the transmitting device may again ascertain whether the count of the unacknowledged frames is smaller than the threshold value. If it is determined that the count of the unacknowledged frames is greater than or equal to the threshold value, the transmitting device may transmit a second packet requesting an immediate block acknowledgement for the unacknowledged frames. The transmitting device may receive a block acknowledgement for the unacknowledged frames in response to receipt of the second packet by the receiving device.

As will be appreciated, the transmitting device, in some examples, sends a packet requiring immediate block acknowledgement depending on the count of the unacknowledged frames so as to utilize a predetermined amount of the BA window size. In particular, a packet requiring the immediate block acknowledgement is sent when the count of the unacknowledged frames becomes equal to or exceeds the threshold value. In some examples, the threshold value may be selected to be at least 50% of the BA window size. Accordingly, depending on the selection of the threshold value, a major portion of the BA window size may be utilized to indicate the status corresponding to the unacknowledged frames. Such selective use of the block acknowledgement causes a reduction in the number of block acknowledgements transmitted by the receiving device and respective other overheads (e.g., SIFS). In particular, as a result, it saves airtime and improves AMPDU efficiency. As will be illustrated in the description later, in some examples, the proposed method reduces airtime by about 6%-7% in the case of large frames (e.g., having a frame size of 1500 Bytes); and by about 14%-16% in the case of mid-size frames (e.g., having frame size of 500 Bytes) in comparison to transmitting immediate block acknowledgements for each packet individually.

The following detailed description refers to the accompanying drawings. Wherever possible, the same reference numbers are used in the drawings and the following description to refer to the same or similar parts. It is to be expressly understood that the drawings are for the purpose of illustration and description only. While several examples are described in this document, modifications, adaptations, and other implementations are possible. Accordingly, the following detailed description does not limit disclosed examples. Instead, the proper scope of the disclosed examples may be defined by the appended claims.

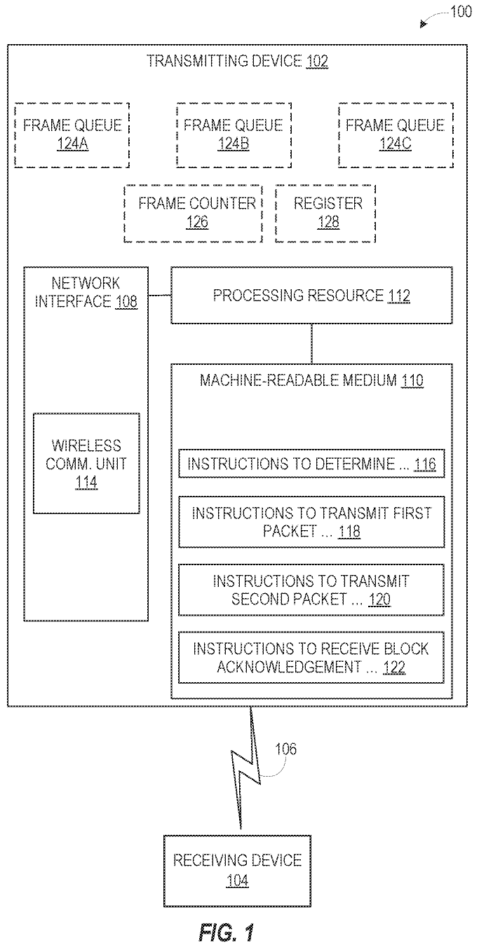

Before describing examples of the disclosed systems and methods in detail, it is useful to describe an example network installation with which these systems and methods might be implemented in various applications. FIG. 1 illustrates a system 100 in which various of the examples presented herein may be implemented. The system 100 may include a transmitting device 102 and a receiving device 104. The transmitting device 102 is communicatively coupled to the receiving device 104 via a communication link 106. Although not shown; in some examples, the system 100 of FIG. 1 may include one or more additional network devices that are distributed among one or more sites. The sites may be located in the same building or are geographically separated and are in communication with each. Further, examples of network devices that may be deployed in the system 100 may include, but are not limited to, access points, wireless local area network controllers (WLAN controllers), network switches, routers, network gateways, client devices, or servers.

The transmitting device 102 and the receiving device 104 may be electronic devices that are capable of communicating with each other via wired and/or wireless communication techniques. Examples of electronic devices that can be implemented as the transmitting device and/or the receiving device 104, may include desktop computers, laptop computers, servers, web servers, authentication servers, WLAN controllers, a wireless access point (AP), authentication-authorization-accounting (AAA) servers, Domain Name System (DNS) servers, Dynamic Host Configuration Protocol (DHCP) servers, Internet Protocol (IP) servers, Virtual Private Network (VPN) servers, network policy servers; mainframes, tablet computers, e-readers, netbook computers, televisions and similar monitors (e.g., smart TVs), content receiving devices, set-top boxes, personal digital assistants (PDAs), mobile phones, smartphones, smart terminals, dumb terminals, virtual terminals, video game consoles, virtual assistants, IOT devices, and the like. In some examples, the transmitting device 102 and the receiving device 104 communicate with each other in accordance with IEEE 802.11 communication standards. For example, in one implementation, the transmitting device 102 may be an access point and the receiving device 104 may be a client device (e.g., any of the above example devices listed hereinabove). It is to be noted that the transmitting device 102 may have a data receiving capability and the receiving device 104 may have data transmission capability.

In some examples, the transmitting device 102 may include a network interface 108, a machine-readable storage medium 110, and a processing resource 112. The network interface 108 may enable the transmitting device 102 to communicate with other network devices. In particular, the transmitting device 102 may communicate with the receiving device 104 via the network interface 108. The network interface 108 may include one or more connectivity media. In the example implementation of FIG. 1, the network interface 108 is shown to include a connectivity medium such as a wireless communication unit 114 (e.g., Wi-Fi chip/module) that may allow communication in accordance with IEEE 802.11 standards or any other communication standards and/or techniques.

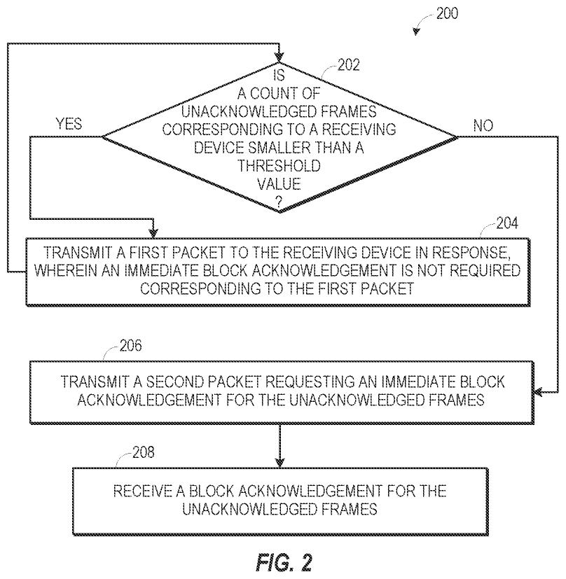

The machine-readable storage medium 110 may be non-transitory and is alternatively referred to as a non-transitory machine-readable storage medium 110 that does not encompass transitory propagating signals. The machine-readable storage medium 110 may be any electronic, magnetic, optical, or any other storage device that may store data and/or executable instructions. Examples of the machine-readable storage medium 110 that may be used in the transmitting device 102 may include Random Access Memory (RAM), non-volatile RAM (NVRAM), an Electrically Erasable Programmable Read-Only Memory (EEPROM), a storage drive (e.g., a solid-state drive (SSD) or a hard disk drive (HDD)), a flash memory, a CD-ROM, and the like. The machine-readable storage medium 110 may be encoded with executable instructions 116, 118, 120, and 122 (hereinafter collectively referred to as instructions 116-122) for performing the method 200 described in FIG. 2, for example. Although not shown, in some examples, the machine-readable storage medium 110 may be encoded with certain additional executable instructions to perform any other operations performed by the transmitting device 102, without limiting the scope of the present disclosure.

The processing resource 112 may be a physical device, for example, a central processing unit (CPU), a microprocessor, a microcontroller, a graphics processing unit (GPU), a field-programmable gate array (FPGA), application-specific integrated circuit (ASIC), other hardware devices capable of retrieving and executing instructions stored in the machine-readable storage medium 110, or combinations thereof. The processing resource 112 may fetch, decode, and execute the instructions stored in the machine-readable storage medium 110 to control transmissions of block acknowledgements to improve airtime efficiency. As an alternative or in addition to executing the instructions 116-122, the processing resource 112 may include at least one integrated circuit (IC), control logic, electronic circuits, or combinations thereof that include a number of electronic components for performing the functionalities intended to be performed by the transmitting device 102.

In certain examples, the transmitting device 102 may store multiple frame queues 124A, 124B, 124C. Each of the frame queues 124A-124C may be associated with a unique traffic identifier (TID). The acknowledgement policy for each TID may be negotiated (described later) between the transmitting device 102 and the receiving device (e.g., receiving device 104). The frame queues 124A-124C may be maintained as a database, physical storage, or virtual storage at the transmitting device 102. In some examples, the frame queues 124A-124C may be stored in the machine-readable storage medium 110. The frame queues 124A-124C store several frames to be transmitted by the transmitting device for the respective TIDs. To transmit a traffic corresponding to a given TID, the processing resource 112, may select a plurality of frames from the respective frame queue of the frame queues 124A-124C and form an aggregated frame unit, for example, an AMPDU.

Further, in some examples, the transmitting device 102 may include a frame counter 126 to keep a count of unacknowledged frames per TID. The frame counter 126 may be a software-based variable or a hardware-based circuit implemented using logic gates. In particular, the value of the frame counter 126 may be incremented each time a frame is transmitted and based on the number of frames transmitted by the transmitting device 102. The value of the frame counter 126 may be decremented upon receiving, by the transmitting device 102, a block acknowledgement and based on the number of frames acknowledged by the receiving device. Accordingly, at any given time, the value of the frame counter 126, corresponding to a given TIS, represents the number of frames that are unacknowledged by the receiving device.

Also, in some examples, the transmitting device 102 may include a register 128 to store a threshold value. In some examples, the register 128 may be implemented as a software-based variable or a physical storage/memory space. The processing resource 112 uses the threshold value stored in the register 128 to decide on when to request an immediate block acknowledgement. The threshold value may be preconfigured or a customizable value. The threshold value may be selected as a function of the BA window size. In one example implementation, the threshold value may be set to 75% of the BA window size. In some examples, the threshold value may be set to any value in a range from 50% of the BA window size to 100% of the BA window size.

The communication link 106 may be a wired or wireless communication link allowing communication between the transmitting device 102 and the receiving device 104. The communication link 106 may include third-party telecommunication lines, such as phone lines, broadcast coaxial cable, fiber optic cables, satellite communications, cellular communications, WLAN, and the like. In some examples, the communication link 106 may also include any number of intermediate network devices, such as switches, routers, gateways, servers, and/or controllers. Examples of the communication link 106 may include an Internet Protocol (IP) or non-IP-based local area network (LAN), wireless LAN (WLAN), metropolitan area network (MAN), wide area network (WAN), a storage area network (SAN), a personal area network (PAN), a cellular communication network, a Public Switched Telephone Network (PSTN), and the Internet.

In some examples, the communication link 106 may include one or more network switches, routers, network gateways, or wireless network controllers to facilitate data communication. Communication over the communication link 106 may be performed in accordance with various communication protocols such as, but not limited to, Transmission Control Protocol and Internet Protocol (TCP/IP), User Datagram Protocol (UDP), IEEE 802.11, and/or cellular communication protocols. The communication over the communication link 106 may be enabled via wired (e.g., copper, optical communication, etc.) or wireless (e.g., Wi-Fi®, cellular communication, satellite communication, Bluetooth, etc.) communication technologies. In some examples, the communication link 106 may be enabled via private communication links including, but not limited to, communication links established via Bluetooth, cellular communication, optical communication, radio frequency communication, wired (e.g., copper), and the like. The private communication links may be direct communication links between the transmitting device 102 and the receiving device 104.

In some examples, the transmitting device 102 may be configured to communicate with the receiving device 104 by transmitting aggregated frame units such as AMPDUs. As previously described, an AMPDU bundles together a plurality of frames (e.g., MSDUs), The receiving device 104 may acknowledge receipt of the AMPDU depending on a negotiated acknowledgement policy. The existing Wi-Fi standards support two types of block acknowledgement policies—an immediate block acknowledgement and a delayed block acknowledgement. The block acknowledgement policy may be negotiated between the transmitting device 102 and the receiving device 104 in advance of communicating the AMPDUs. The immediate block acknowledgement is generally used for low-latency and high-throughput traffic, for example, voice and video traffic. Whereas the delayed block acknowledgement is generally used for traffic that can tolerate moderate or low levels of latency also referred to as latency tolerant traffic.

Once negotiated, the transmitting device requests acknowledgement from the receiving device 104 as per the agreed block acknowledgement policy. For example, during the communication setup phase, the transmitting device 102 may establish a block acknowledgement session with the receiving device 104 by sending an Add Block Acknowledgment (ADDBA) Request and receiving Add Block Acknowledgment (ADDBA) response. In particular, the transmitting device 102 may set a block acknowledgement policy field in the ADDBA request to 1 to configure an immediate block acknowledgement type. Similarly, the transmitting device 102 may set the block acknowledgement policy field in the ADDBA request to 0 if a delayed block acknowledgement type is to be configured. Further, the ADDBA request may contain a TID field indicating a traffic type for which the block acknowledgement session is requested. Further, the ADDBA request may also include a timeout value which indicates a duration after which a block acknowledgement session will be terminated if no frame exchanges occur.

In accordance with some examples, the transmitting device 102 controls the transmissions of the block acknowledgements resulting in significant airtime savings. In particular, the transmitting device 102 implements an aggregate block acknowledgement to leverage increased BA window size. In some examples, a transmitting device 102 is configured to request an immediate block acknowledgement depending on the BA window size and a count of unacknowledged frames. In particular, the transmitting device 102 may be configured to send packets with frames requiring a delayed block acknowledgement until the count of the unacknowledged frames reaches a threshold value. More particularly, in one example, the transmitting device 102 requests the immediate block acknowledgement upon determining that the count of unacknowledged frames is greater than or equal to the threshold value. The threshold value may be set to a predetermined percentage (e.g., 75%) of the BA window size. By doing so, a major portion of the BA window size may be utilized, and frequent transmission of the block acknowledgements may be avoided.

In particular, in some examples, by way of the processing resource 112 executing the instructions 116, the transmitting device 102 may first determine whether a count of unacknowledged frames corresponding to the receiving device 104 (e.g., a number of frames that the received has not acknowledged at a given point in time) is smaller than the threshold value. Further, by way of the processing resource 112 executing the instructions 118, the transmitting device 102 may transmit a first aggregated frame unit (hereinafter referred to as a first packet) to the receiving device 104 in response to determining that the count of the unacknowledged frames is smaller than the threshold value. In particular, the transmitting device 102 configures the first packet such that the receiving device 104 need not send a block acknowledgement immediately after receiving the first packet. Further, after the transmission of the first frame and before transmitting any additional packet to the receiving device, the transmitting device 102, by way of the processing resource 112 executing the instructions 116, may again ascertain whether the count of the unacknowledged frames is smaller than the threshold value. If it is determined that the count of the unacknowledged frames is greater than or equal to the threshold value, the transmitting device 102, by way of the processing resource 112 executing the instructions 120, may transmit a second aggregated frame unit (hereinafter referred to as a second packet) requesting an immediate block acknowledgement for the unacknowledged frames. The transmitting device 102 by way of the processing resource 112 executing the instructions 122, may receive a block acknowledgement for the unacknowledged frames in response to receipt of the second packet by the receiving device.

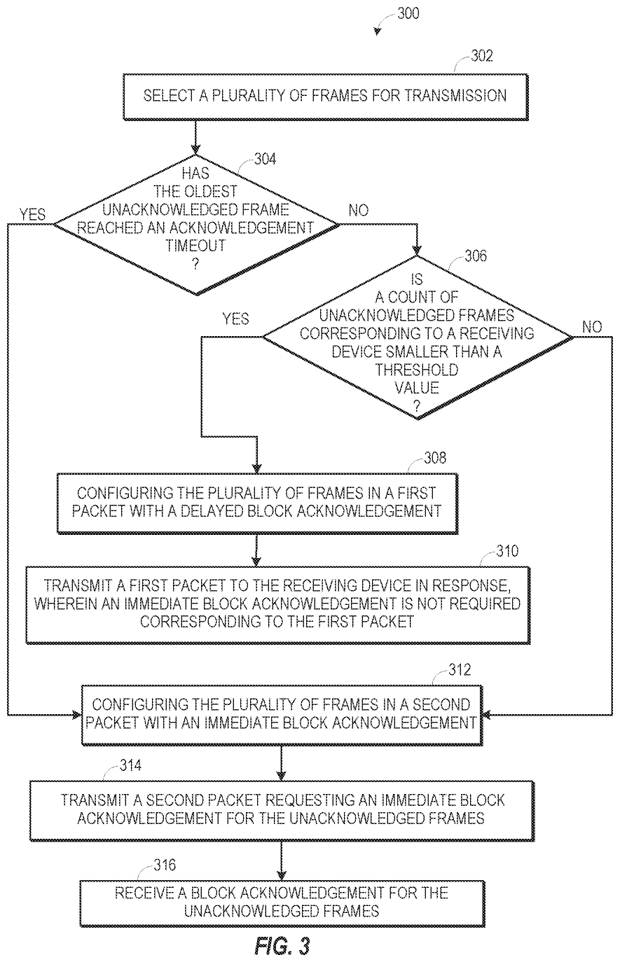

FIGS. 2 and 3 respectively represent example methods 200 and 300 for handling block acknowledgements. Each of the flowcharts of the methods 200 and 300 depicted in FIGS. 2-3 includes several steps in an order. However, the order of steps shown in FIGS. 2-3 should not be construed as the only order for the steps. The steps may be performed at any time, in any order. Additionally, the steps may be repeated or omitted as needed. In some examples, the steps shown in FIGS. 2-3 may be performed by any suitable device implementing IEEE 802.11 standard. Any such suitable device may be a transmitting device (e.g., the transmitting device 102 described above).

Referring now to FIG. 2, at step 202, the transmitting device may perform a check to determine whether a count of the unacknowledged frames (for example, as maintained by a frame counter) is less than a threshold value. In particular, the transmitting device may perform the step 202 while preparing an aggregated frame unit (e.g., an AMPDU). In some examples, the processing resource of the transmitting device references a frame counter and a threshold register to obtain the count of the unacknowledged frames and the threshold value, respectively. At step 202, if it is determined that the count of the unacknowledged frames is less than the threshold value, the transmitting device, at step 204, transmits a first packet to the receiving device. In some examples, the transmitting device configures the first packet such that the receiving device need not send block acknowledgement to the transmitting device immediately after the receipt of the first packet. Once the first packet is sent, the transmitting device may prepare for sending another set of frames and before such transmission may again perform a check at step 202 to determine whether the count of the unacknowledged frames is still less than the threshold value.

At step 202, if it is determined that the count of the unacknowledged frames is not less than the threshold value (i.e., the count of the unacknowledged frames is greater than or equal to the threshold value), the transmitting device, at step 206, transmits a second packet to the receiving device. The transmitting device requests immediate block acknowledgement for the unacknowledged frames in the second packet sent to the receiving device. In response to the receipt of such a second packet requesting immediate block acknowledgement, the receiving device sends a block acknowledgement to the transmitting device confirming the reception status of transmitted frames. At step 208, the transmitting device receives the block acknowledgement from the receiving device.

As described hereinabove, the transmitting device does not request the receiving device to immediately send block acknowledgement until the count of the unacknowledged frames is smaller than the threshold value. In particular, the transmitting device sends a packet requesting immediate block acknowledgement after the count of the unacknowledged frames becomes greater than or equal to the threshold value. Such configurations of packets by the transmitting device refrains the receiving device from sending the block acknowledgements frequently. Accordingly, depending on the selection of the threshold value relative to the BA window size, a major portion of the BA window size may be utilized to indicate the status corresponding to the unacknowledged frames. Also, the reduction in the number of block acknowledgements transmitted by the receiving device and respective other overheads (e.g., SIFS) results in improving airtime efficiency. In particular, the proposed example method is especially efficient in cases where the number of frames that make up the aggregated frame unit is much smaller than the number of frames that one block acknowledgement can acknowledge (i.e., the BA window size). By delaying the immediate acknowledgement request until the threshold value is reached, better airtime efficiency by causing a significantly lower number of SFS and block acknowledgement frames.

Referring now to FIG. 3, another example method 300 of controlling block acknowledgements is presented. The method 300 of FIG. 3 may be an example representative of the method 200 of FIG. 2 and include some steps that are similar to those described in FIG. 2, certain description of which is not repeated herein.

At step 302, a transmitting device selects a plurality of frames to be transmitted as part of an aggregated frame unit from a frame queue corresponding to a TID. Further, at step 304, the transmitting device may perform a check to determine whether the oldest unacknowledged frame has not reached an acknowledgement timeout. In some examples, the transmitting device maintains a timer corresponding to each transmitted frame to keep a track of whether the timer has attained a timeout. The transmitting device is configured to request block acknowledgement if the oldest unacknowledged frame has reached the acknowledgement timeout. At step 304, if it is determined that the oldest unacknowledged frame has not reached the acknowledgement timeout, the transmitting device, at step 306, may perform another check to determine whether a count of the unacknowledged frames is less than a threshold value. At step 306, if it is determined that the count of the unacknowledged frames is less than the threshold value, the transmitting device, at step 308, configures a first packet such that the receiving device need not send block acknowledgement to the transmitting device immediately after the receipt of the first packet. In particular, the transmitting device configures the frames in the first packet with delayed block acknowledgement.

Generally, frames that form an aggregated frame unit such as the first packet (e.g., a first AMPDU) may include QoS control bits in respective frame headers. Table-1 presented below represents example settings of such QoS control bits.

TABLE 1
Example settings of the QoS control bits

| QoS Control Bits | | |
|---|---|---|
| First bit | Second bit | Intended use |
| 0 | 0 | Immediate block acknowledgement |
| 0 | 1 | No explicit acknowledgement |
| 1 | 0 | No acknowledgement |
| 1 | 1 | Delayed block acknowledgement |
| | | The addressed recipient takes no action upon the |
| | | receipt of the frame except for recording the state. |

Different values of these QoS control bits may be used to control the block acknowledgement behaviour. In particular, in one example, the first bit and the second bit shown in Table-1 may represent QoS control bit-S and bit-S in the 802.11 frame header. The acknowledgement behavior can be controlled by setting these control bits in the frame headers as illustrated in Table-1, In some examples, at step 308, the transmitting device may set the QoS control bits (first bit, second bit) in the frame headers of each frame in the first packet to 1, 1. Once the frames are configured with the delayed block acknowledgement by setting the QoS control bits, the transmitting device, at step 310, transmits the first packet to the receiving device.

Referring again to step 304, if it is determined that the oldest unacknowledged frame has reached the acknowledgement timeout, the transmitting device may execute the step 312. Also, at step 306, if it is determined that the count of the unacknowledged frames is not smaller than the threshold value, the transmitting device may execute the step 312. At step 312, the transmitting device configures a second packet such that the receiving device will send the block acknowledgement to the transmitting device immediately after the receipt of the second packet. In particular, the transmitting device configures the frames in the second packet with an immediate block acknowledgement. In some examples, as per the QoS control settings shown in Table-1, the transmitting device may set the QoS control bits (first bit, second bit) in the frame headers of each frame in the second packet to 0, 0. Once the frames are configured with the immediate block acknowledgement by setting the QoS control bits, the transmitting device, at step 314, transmits the second packet to the receiving device. In response to the receipt of such a second packet requesting immediate block acknowledgement, the receiving device sends a block acknowledgement to the transmitting device confirming the reception status of transmitted frames. At step 316, the transmitting device receives the block acknowledgement from the receiving device.

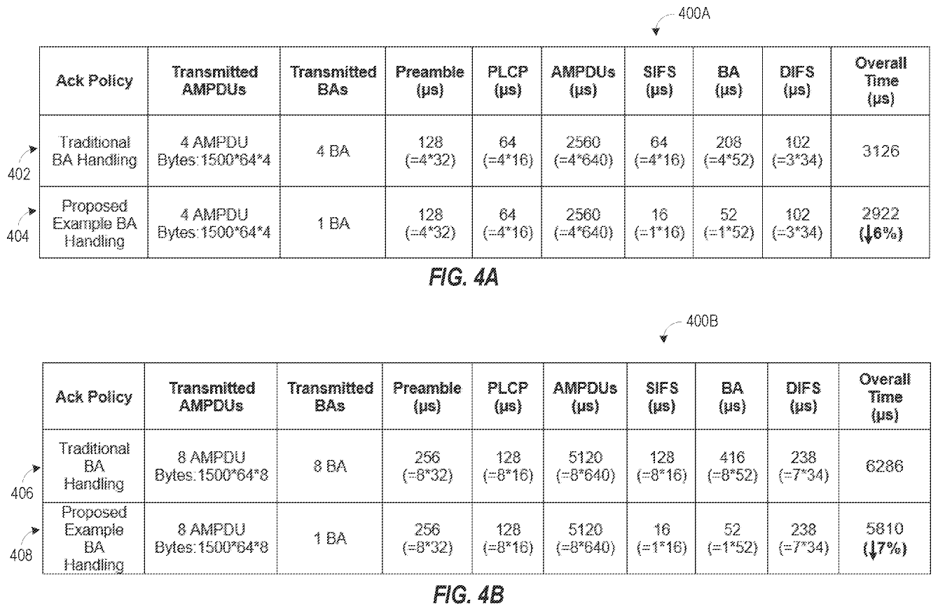

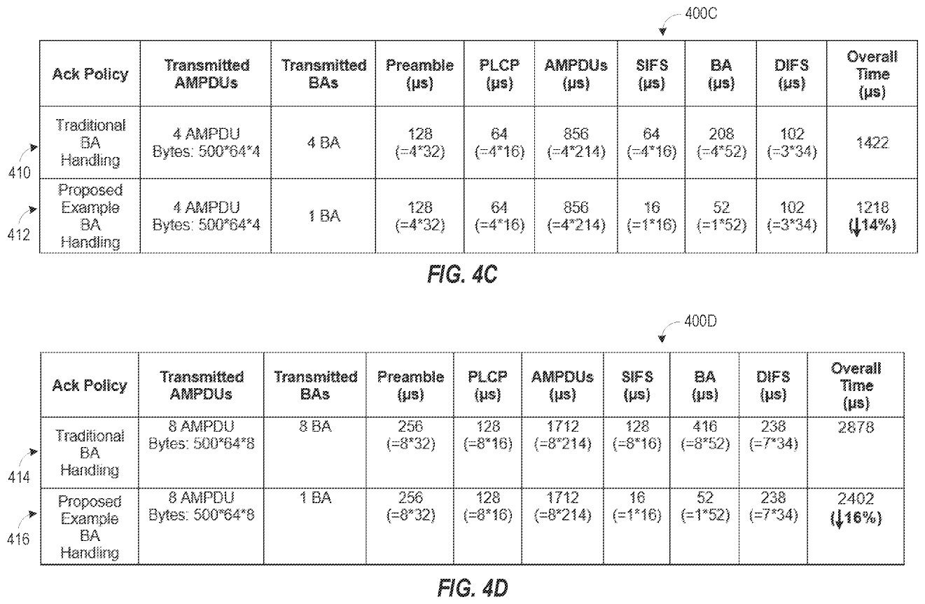

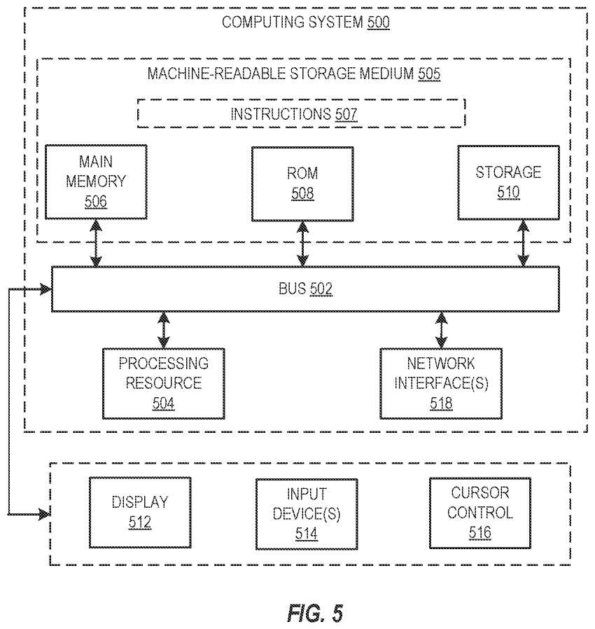

FIGS. 5A, 5B, 5C, and 5D represent example scenarios illustrating a reduction in airtime usage (which is indicative of an improvement in airtime efficiency). In particular, in an experimental scenario of FIGS. 4A-4D, the data rate is set to 1.2 Gigabits per second (Gbps), BA window size is set to 512 bits, and the number of frames in an AMPDU is set to 64. Further, each AMPDU includes a preamble field using 32 μs of airtime, and a Physical Layer Convergence Protocol (PLOP) header using 16 μs of airtime. Further, the transmission of a single block acknowledgement consumes 52 μs of airtime, using SIFS of 16 μs, and Distributed coordination function Inter Frame Space (DIFS) of 34 μs. FIG. 4A depicts a table 400A illustrating a reduction in the airtime usage with example transmission of a single block acknowledgement for four AMPDUs over a traditional transmission of a block acknowledgement for each of the four AMPDUs, with the AMPDUs including frames with a frame size of 1500 bytes. For 64 frames, each having the frame size of 1500 bytes, the total frame size in an AMPDU becomes 64*1500*8=768000 bits, which consumes airtime of 768000 bits/1.2 Gbps=640 microseconds (μs). Accordingly, as depicted in row 402 representing a traditional scenario that uses transmission of four block acknowledgements (i.e., one block acknowledgement for every AMPDU) consumes 3126 μs of airtime for communication of a total of four AMPDUs. In comparison, the experimental scenario depicted in row 404, in accordance with some examples of the present disclosure, uses only one block acknowledgement for four AMPDUs utilizing 2922 μs of airtime resulting in 6% less airtime usage over the traditional acknowledgement handling.

In some examples, the airtime usage may further be reduced if the number of AMPDUs acknowledged by a single block acknowledgement is increased (for example, by way of increasing the threshold value). In particular, FIG. 4B depicts a table 400B illustrating an improvement in airtime efficiency with example transmission of a single block acknowledgement for eight AMPDUs over a traditional transmission of a block acknowledgement for each of the eight AMPDUs, with the AMPDUs including frames with a frame size of 1500 bytes. Accordingly, as depicted in row 406 representing a traditional scenario that uses transmission of eight block acknowledgements (i.e., one block acknowledgement for every AMPDU) consumes 6286 μs of airtime for communication of a total of eight AMPDUs. In comparison, the experimental scenario depicted in row 408, in accordance with some examples of the present disclosure, uses only one block acknowledgement for eight AMPDUs utilizing 5810 μs of airtime resulting in 7% less airtime usage over the traditional acknowledgement handling.

Furthermore, in some examples, the airtime usage reduces with a reduction in the frame size. For example, FIG. 4C depicts a table 400C illustrating an improvement in airtime efficiency with example transmission of a single block acknowledgement for four AMPDUs over a traditional transmission of a block acknowledgement for each of the four AMPDUs, with the AMPDUs including frames with a frame size of 500 bytes. For 64 frames, each having a frame size of 500 bytes, the total frame size in an AMPDU becomes 64*500*8=255000 bits, which consumes airtime of 255000 bits/1.2 Gbps=214 microseconds (μs). Accordingly, as depicted in row 410 representing a traditional scenario that uses transmission of four block acknowledgements (i.e., one block acknowledgement for every AMPDU) consumes 1422 μs of airtime for communication of a total of four AMPDUs. In comparison, the experimental scenario depicted in row 412, in accordance with some examples of the present disclosure, uses only one block acknowledgement for four AMPDUs utilizing 1218 μs of airtime resulting in 14% less airtime usage over the traditional acknowledgement handling.

Moreover, the airtime usage may further be reduced if the number of AMPDUs acknowledged by a single block acknowledgement is increased (for example, by way of increasing the threshold value) with the reduced frame size. For example, FIG. 4D depicts a table 400D illustrating an improvement in airtime efficiency with example transmission of a single block acknowledgement for eight AMPDUs over a traditional transmission of a block acknowledgement for each of the eight AMPDUs, with the AMPDUs including frames with the frame size of 500 bytes. Accordingly, as depicted in row 414 representing a traditional scenario that uses transmission of eight block acknowledgements (i.e., one block acknowledgement for every AMPDU) consumes 2878 μs of airtime for communication of a total of eight AMPDUs. In comparison, the experimental scenario depicted in row 416, in accordance with some examples of the present disclosure, uses only one block acknowledgement for eight AMPDUs utilizing 2402 μs of airtime resulting in a massive 16% reduction in airtime usage over the traditional acknowledgement handling.

FIG. 5 depicts a block diagram of an example computing system 500 in which various of the examples described herein may be implemented. In some examples, the computing system 500 may be configured to operate as a transmitting device. The computing system 500 may include a bus 502 or other communication mechanisms for communicating information, a hardware processor, also referred to as processing resource 504, coupled to the bus 502 for processing information. The processing resource 504 may be, for example, one or more general-purpose microprocessors. The computing system 500 may also include a non-transitory machine-readable storage medium 505 communicatively coupled to the bus 502. In some examples, the machine-readable storage medium 505 may include a main memory 506, such as a random-access memory (RAM), cache and/or other dynamic storage devices, coupled to the bus 502 for storing information and instructions to be executed by the processing resource 504. The main memory 506 may also be used for storing temporary variables or other intermediate information during the execution of instructions to be executed by the processing resource 504. Such instructions, when stored in storage media accessible to the processing resource 504, render the computing system 500 into a special-purpose machine that is customized to perform the operations specified in the instructions.

The machine-readable storage medium 505 may further include a read-only memory (ROM) 508 or other static storage device coupled to the bus 502 for storing static information and instructions for the processing resource 504. Further, in the machine-readable storage medium 505, a storage device 510, such as a magnetic disk, optical disk, or USB thumb drive (Rash drive), etc., may be provided and coupled to the bus 502 for storing information and instructions.

Further, in some implementations, the computing system 500 may be coupled, via the bus 502, to a display 512, such as a liquid crystal display (LCD) (or touch-sensitive screen), for displaying information to a computer user. In some examples, an input device 514, including alphanumeric and other keys (physical or software generated and displayed on touch-sensitive screen), may be coupled to the bus 502 for communicating information and command selections to the processing resource 504. Also, in some examples, another type of user input device may be a cursor control 516, such as a mouse, a trackball, or cursor direction keys may be connected to the bus 502. The cursor control 516 may communicate direction information and command selections to the processing resource 504 for controlling cursor movement on the display 512. In some other examples, the same direction information and command selections as cursor control may be implemented via receiving touches on a touch screen without a cursor.

In some examples, the computing system 500 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

The computing system 500 also includes a network interface 518 coupled to bus 502. The network interface 518 provides a two-way data communication coupling to one or more network links that are connected to one or more local networks. For example, the network interface 518 may be an integrated services digital network (ISDN) card, cable modem, satellite modem, or a modem to provide a data communication connection to a corresponding type of telephone line. As another example, the network interface 518 may be a local area network (LAN) card or a wireless communication unit (e.g., Wi-Fi chip/module).

In some examples, the machine-readable storage medium 505 (e.g., one or more of the main memory 506, the ROM 508, or the storage device 510) may store instructions 507 which when executed by the processing resource 504 may cause the processing resource 504 to execute one or more of the methods (e.g., methods 200 or 300) described hereinabove. The instructions 507 may be stored on any of the main memory 506, the ROM 508, or the storage device 51a In some examples, the instructions 507 may be distributed across one or more of the main memory 506, the ROM 508, or the storage device 510.

Terms and phrases used in this document, and variations thereof, unless otherwise expressly stated, should be construed as open-ended as opposed to limiting. As examples of the foregoing, the term “including” should be read as meaning “including, without limitation” or the like. The term “example” is used to provide exemplary instances of the item in the discussion, not an exhaustive or limiting list thereof. The terms “a” or “an” should be read as meaning “at least one,” “one or more” or the like. The presence of broadening words and phrases such as “one or more,” “at least,” “but not limited to” or other like phrases in some instances shall not be read to mean that the narrower case is intended or required in instances where such broadening phrases may be absent. Further, the term “and/or” as used herein refers to and encompasses any and all possible combinations of the associated listed items. It will also be understood that, although the terms first, second, etc., may be used herein to describe various elements, these elements should not be limited by these terms, as these terms are only used to distinguish one element from another unless stated otherwise or the context indicates otherwise.

What is claimed is:

1. A method comprising:
determining, by a transmitting device, whether a count of unacknowledged frames corresponding to a receiving device is smaller than a threshold value;
transmitting, by the transmitting device, a first packet to the receiving device in response to determining that the count of the unacknowledged frames is smaller than the threshold value, wherein the transmitting device configures the first packet such that the receiver is not required to send block acknowledgement immediately upon receipt of the first packet by the receiver;
determining, by the transmitting device after transmitting the first packet, whether the count of the unacknowledged frames is smaller than the threshold value;
transmitting, by the transmitting device, a second packet requesting immediate block acknowledgement for the unacknowledged frames in response to determining that the count of the unacknowledged frames is greater than or equal to the threshold value; and
receiving, by the transmitting device, a block acknowledgement for the unacknowledged frames in response to receipt of the second packet by the receiving device.

2. The method of claim 1, wherein the first packet and the second packet are Aggregated MAC Protocol Data Units (AMPDUs) each comprising a plurality of frames.

3. The method of claim 2, further comprising selecting the plurality of frames from a frame queue corresponding to a traffic identifier (TID).

4. The method of claim 3, wherein the TID corresponds to a latency tolerant traffic.

5. The method of claim 1, further comprising configuring a plurality of frames in the first packet with a delayed block acknowledgement by setting predefined control bits in frame headers of the plurality of frames.

6. The method of claim 1, further comprising configuring a plurality of frames in the second packet with the immediate block acknowledgement by setting predefined control bits in frame headers of the plurality of frames.

7. The method of claim 1, further comprising determining, by the transmitting device, whether the oldest unacknowledged frame has not reached an acknowledgement timeout, wherein the transmitting device transmits the first packet to the receiving device in response to determining that the oldest unacknowledged frame has not reached the acknowledgement timeout and the count of the unacknowledged frames is smaller than the threshold value.

8. The method of claim 7, wherein the transmitting device transmits the second packet in response to determining that the oldest unacknowledged frame has reached the acknowledgement timeout or the count of the unacknowledged frames is greater than or equal to the threshold value.

9. The method of claim 1, wherein the threshold value is determined based on a size of the block acknowledgement.

10. The method of claim 1, wherein the threshold value is 75% of a size of the block acknowledgement.

11. The method of claim 1, wherein the transmitting device is an access point.

12. A transmitting device, comprising:
a machine-readable storage medium storing executable instructions; and
a processing resource coupled to the machine-readable storage medium, wherein the processing resource executes one or more of the instructions to:
determine whether a count of unacknowledged frames corresponding to a receiving device is smaller than a threshold value;
transmit a first packet to the receiving device in response to determining that the count of the unacknowledged frames is smaller than the threshold value, wherein the processing resource configures the first packet such that the receiver is not required to send block acknowledgement immediately upon receipt of the first packet by the receiver;
determine, after the transmission of the first packet, whether the count of the unacknowledged frames is smaller than the threshold value;
transmit a second packet requesting an immediate block acknowledgement for the unacknowledged frames in response to determining that the count of the unacknowledged frames is greater than or equal to the threshold value; and
receive a block acknowledgement for the unacknowledged frames in response to receipt of the second packet by the receiving device.

13. The transmitting device of claim 12, comprises a frame queue corresponding to a TID, wherein the processing resource selects a plurality of frames from the frame queue to form the first packet and the second packet.

14. The transmitting device of claim 12, further comprising a counter that maintains the count of the unacknowledged frames corresponding to the receiving device.

15. The transmitting device of claim 12, wherein the threshold value is a value in a range from 50% to 100% of a size of the block acknowledgement.

16. The transmitting device of claim 12, wherein transmitting the second packet requesting the immediate block acknowledgement after the count of the unacknowledged frames becomes equal to greater than the threshold value avoids frequent transmissions of block acknowledgements from the receiving device thereby resulting in airtime savings.

17. The transmitting device of claim 12, wherein transmitting the second packet requesting the immediate block acknowledgement after the count of the unacknowledged frames becomes equal to greater than the threshold value avoids frequent transmissions of block acknowledgements from the receiving device thereby resulting in airtime reduction from 6% to 7% for a frame size of 1500 bytes or from 14% to 16% for a frame size of 500 bytes in comparison to transmitting immediate block acknowledgements for each packet individually.

18. A system comprising:
a receiving device; and
a transmitting device communicatively coupled to the receiving device via a communication link, wherein the transmitting device is configured to:
determine whether a count of unacknowledged frames corresponding to the receiving device is smaller than a threshold value;
transmit a first packet to the receiving device in response to determining that the count of the unacknowledged frames is smaller than the threshold value, wherein the transmitting device configures the first packet such that the receiver is not required to send block acknowledgement immediately upon receipt of the first packet by the receiver;
determine, after the transmission of the first packet, whether the count of the unacknowledged frames is smaller than the threshold value;
transmit a second packet requesting an immediate block acknowledgement for the unacknowledged frames in response to determining that the count of the unacknowledged frames is greater than or equal to the threshold value; and
receive a block acknowledgement for the unacknowledged frames in response to receipt of the second packet by the receiving device.

19. The system of claim 18, wherein the transmitting device is an access point and the receiving device is a client device, and wherein the communication link is a wireless communication link supporting IEEE 802.11 standard.

20. The system of claim 18, wherein the transmitting device is configured to:
determine whether the oldest unacknowledged frame has not reached an acknowledgement timeout;
transmit the first packet to the receiving device in response to determining that the oldest unacknowledged frame has not reached the acknowledgement timeout and the count of the unacknowledged frames is smaller than the threshold value; and
transmit the second packet in response to determining that the oldest unacknowledged frame has reached the acknowledgement timeout or the count of the unacknowledged frames is greater than or equal to the threshold value.
